(19) United States
(12) Patent Application Publication
(10) Pub. No.: US 2006/0179806 A1
(43) Pub. Date: Aug. 17, 2006

(54) Carrying system for an implement and method for cutting trees

(75) Inventors: Georg Maier, Kernen (DE); Wolfgang Layher, Waiblingen (DE); Gunter Mayer, Untereisesheim (DE); Christoph Winkler, Stuttgart (DE); Carl-Philipp Clarenbach, Karlsruhe (DE); Tobias Leininger, Karlsruhe (DE); Benjamin Lietz, Karlsruhe (DE); Thomas Neumaier, Karlsruhe (DE); Denys Oparin, Karlsruhe (DE); Achim Seifermann, Iffezheim (DE)

Correspondence Address: ROBERT W. BECKER & ASSOCIATES, Suite B, 707 Highway 66 East, Tijeras, NM, 87059, US

(73) Assignee: Andreas Stihl AG & Co. KG, Waiblingen (DE)

(21) Appl. No.: 11/332,002

(22) Filed: Jan. 13, 2006

(30) Foreign Application Priority Data
Jan. 14, 2005 (DE) 10 2005 001 843.2

(51) Int. Cl. A01D 34/00; E21B 19/16

(52) U.S. Cl. 56/12.7; 173/170; 173/213; 30/276

(57) ABSTRACT

A carrying system for an implement, comprising a carrying arm and a receiving device held on the carrying arm for receiving the guide rod of the implement. In a first state, the receiving device is adapted to fix the guide rod in a longitudinal direction thereof. In a second state, the receiving device is displaceable in the longitudinal direction of the guide rod.

The instant application should be granted the priority date of Jan. 14, 2005, the filing date of the corresponding German patent application 102 005 001 843.2.

### BACKGROUND OF THE INVENTION

The present invention relates to a carrying system for an implement, such as a pole pruner, a palm cutter, a coffee harvester or the like, and a method for cutting a tree with a pole pruner.

DE 25 27 295 A1 discloses fixing a hand tool in position on a support structure that is carried on the back of an operator. The hand tool is connected with the support structure by a chain that is fixed on the hand tool.

With an implement such as a pole pruner, a coffee harvester, a palm cutter, or the like, the guide rod must be rotatable about its longitudinal axis during operation of the implement. However, by fixedly connecting the implement with a carrying system in the region of the center of gravity of the implement, a rotation of the implement about the longitudinal axis of the guide rod is no longer possible. In order to be able to operate at different heights, the guide rod of the implement is more or less inclined during operation. With a fixed arrangement of the guide rod on a carrying system, it is necessary to apply more or less force for the inclination depending on the desired height of operation. To thin out or clear woods, and at the same time to prevent wild growth on tree stumps, it is known to top or lop trees at a prescribed height.

It is an object of the present invention to provide a carrying system for an implement that permits a good operation of the implement without fatigue. A further object of the invention is to provide a method for cutting trees that can be easily carried out.

### BRIEF DESCRIPTION OF THE DRAWINGS

These and other objects and advantages of the present invention will appear more clearly from the following specification in conjunction with the accompanying schematic drawings, in which:

FIGS. 1 & 2 are perspective illustrations of carrying systems;

FIG. 3 is a perspective view of a pole pruner;

FIG. 4 is a perspective view of a receiving means of a carrying system;

FIG. 5 is an exploded view of the receiving means of FIG. 4.

FIG. 6 is a cross-sectional view through the receiving means of FIG. 5;

FIG. 7 is a perspective view of a receiving means of a carrying system;

FIG. 8 is a side view of the receiving means of FIG. 7;

FIG. 9 is a cross-sectional view through the receiving means of a carrying system;

FIGS. 10-12 are perspective views of receiving means of carrying systems; and

FIG. 13 is a perspective view of a carrying system.

### SUMMARY OF THE INVENTION

The inventive carrying system for an implement comprises a carrying arm and a receiving means held on the carrying arm for receiving the guide rod of an implement, wherein in a first state the receiving means is adapted to fix the guide rod in a longitudinal direction thereof, and wherein in a second state the receiving means is displaceable in the longitudinal direction of the guide rod. The method for cutting trees includes the steps of using a pole pruner that is held on a carrying system in the region of its center of gravity, and topping the tree at a prescribed height by cutting all the way around.

Due to the fact that the receiving means fixes the guide rod in a first state, and in a second state can be shifted or displaced in the longitudinal direction of the guide rod, the position of the receiving means on the guide rod can be adapted to the respective operating height. This facilitates working with the implement, and the force that the operator has to exert is reduced, so that a fatigue-free operation is possible with the implement.

It is provided that the receiving means fixes the guide rod of the implement if the weight of the implement loads the carrying arm, and that the receiving means is displaceable relative to the guide rod when the load is relieved. Since the receiving means fixes the guide rod when the weight of the pole pruner is suspended on the carrying arm, a fixing of the receiving means can be achieved merely by releasing the pole pruner. For the release, it is merely necessary to raise the pole pruner. The fixation via a receiving means can also easily be added to existing implements, since no special devices are necessary on the pole pruner itself.

The receiving means can include a connection element that bends easily and is held on the carrying arm, whereby the connection element fixes the guide rod in the connection element during tension, and when the tension is released can be displaced along the guide rod. The fixing of the guide rod by means of a connection element that bends easily permits a rotation of the pole pruner along the longitudinal axis of the guide rod during operation of the pole pruner. The displacement or shifting of the receiving means on the guide rod is easily possible by relieving the load on the connection element and shifting the receiving means. The receiving means with the connection element has a simple construction and a low weight, so that it can be easily manufactured.

Both ends of the connection element are advantageously fixed in position on the carrying arm. By fixing the ends of the connection element on the carrying arm, the height of the receiving means, and hence the height at which the pole pruner is held, can easily be fixed. However, it would also be possible for the connection element to be fixed in position on the carrying arm by means of an adjustment device. By suitable selection of an adjustment device, a rapid and simple adaptation of the distance of the receiving means from the carrying arm is possible. The connection element is advantageously a cable that is held on the guide rod by a Prusik knot. This knot ensures a good fixation of the receiving means on the guide rod when tension exists in the cable. Upon release of the cable, this knot is easily displaceable on the guide rod. To ensure a reliable loosening of the receiving means from the guide rod upon relief of the load of the cable, a guide means can be disposed between the cable and the guide rod, with this guide means being resiliently elastic in a radially upward direction. The resilient elasticity ensures the loosening of the knot. The guide means is advantageously essentially cylindrical, and has a slot that extends in the longitudinal direction of the guide means. In this way, a simple configuration of the guide means can be achieved accompanied by good spring characteristics. The ends of the guide means that are disposed in the longitudinal direction are expediently provided with a collar that faces outwardly from the guide rod. The collar can be easily monolithically produced with the guide means, and in a straightforward manner ensures that the cable cannot slip from the guide means during operation.

The receiving means can have a housing that surrounds that portion of the connection element that is disposed in the region of the guide rod. In this way, it is possible to protect the connection element from dirt and weather influences. The housing is advantageously essentially cylindrical. To prevent dirt from penetrating into the housing, a sealing means is provided between the housing and the guide rod of the pole pruner. The sealing means is advantageously made of felt, thereby achieving a good sealing effect. At the same time, felt has good antifriction properties, so that the housing can easily be shifted on the guide rod.

The receiving means advantageously has a mounting support, whereby a portion of the connection element across from the mounting support is disposed on the guide rod and presses the guide rod against the mounting support. In so doing, the connection element effects a fixation of the guide rod in the mounting support. As long as the weight of the implement presses on the mounting support, the connection element is tensioned and presses the guide rod into the mounting support. When the connection element is relieved by raising the implement, the force of the connection element upon the guide rod is reduced, and the mounting support can be shifted on the guide rod. Both ends of the portion of the connection element are advantageously held on the mounting support, whereby at least one end of the portion is held on the mounting support so as to be movable in its longitudinal direction. This results in a simple construction of the receiving means. The movable fixation of one end of the portion ensures that when the connection element is relieved, the tension in the portion that presses the guide rod into the mounting support is relaxed. The receiving means is expediently provided with an actuating means for loosening the connection element, whereby the actuating means acts upon the movable end of the portion of the connection element. As a result, the loosening of the portion can be actively assisted by the operator. A straightforward configuration is provided if the movable end is held on the mounting support by a loop. It can be advantageous for the portion to rest against a guide means of the receiving means. The connection element is advantageously a strap, which ensures a good introduction of force into the guide rod, and which, due to its small thickness, leads to a small overall size of the receiving means.

The receiving means can be fixed in position on the guide rod via a releasable fixing means. The fixing means is advantageously provided with a clamping lever that holds the receiving means against the guide rod. The clamping lever is in particular spring-mounted, thus ensuring a reliable holding of the receiving means on the guide rod. The clamping lever is advantageously provided with an actuating means for releasing the clamping action. The clamping lever ensures a simple operation, and permits an easy shifting of the receiving means on the guide rod.

The carrying system is expediently provided with a back support. The forces absorbed by the carrying arm can be conveyed directly to the shoulders and hips of the operator via the back support. This makes an ergonomic operation possible. The carrying system can also include a stomach support. The carrying arm is advantageously adjustably held on the back or stomach support, and the carrying system has at least one marking that characterizes a prescribed position of the carrying arm on the support. The marking enables a simple and rapid adjustment of the position of the carrying arm on the support. The marking advantageously correlates with a garment size so that the operator, on the basis of his or her garment size, can readily undertake the adjustment that fits him or her.

Pursuant to a method for cutting trees with a pole pruner that is held on a carrying system in the region of its center of gravity, the tree can be topped at a prescribed height by cutting all the way around.

The cutting at a prescribed height can be carried out in a simple manner with a pole pruner that is held on a carrying system in the region of its center of gravity. Due to the fact that the pole pruner is held in a region of its center of gravity, the guide rod is disposed approximately horizontally or is inclined only slightly relative to the horizontal. As a result, the guide bar of the pole pruner is disposed at a height that is favorable for topping trees. As a result of the fixation of the pole pruner on a carrying system, it is thus possible to carry out a cutting all the way around at a prescribed height in a simple manner.

The tree is advantageously topped at a height of 1.0 m to 1.8 m.

Further specific features of the present application will be described in detail subsequently.

### DESCRIPTION OF SPECIFIC EMBODIMENTS

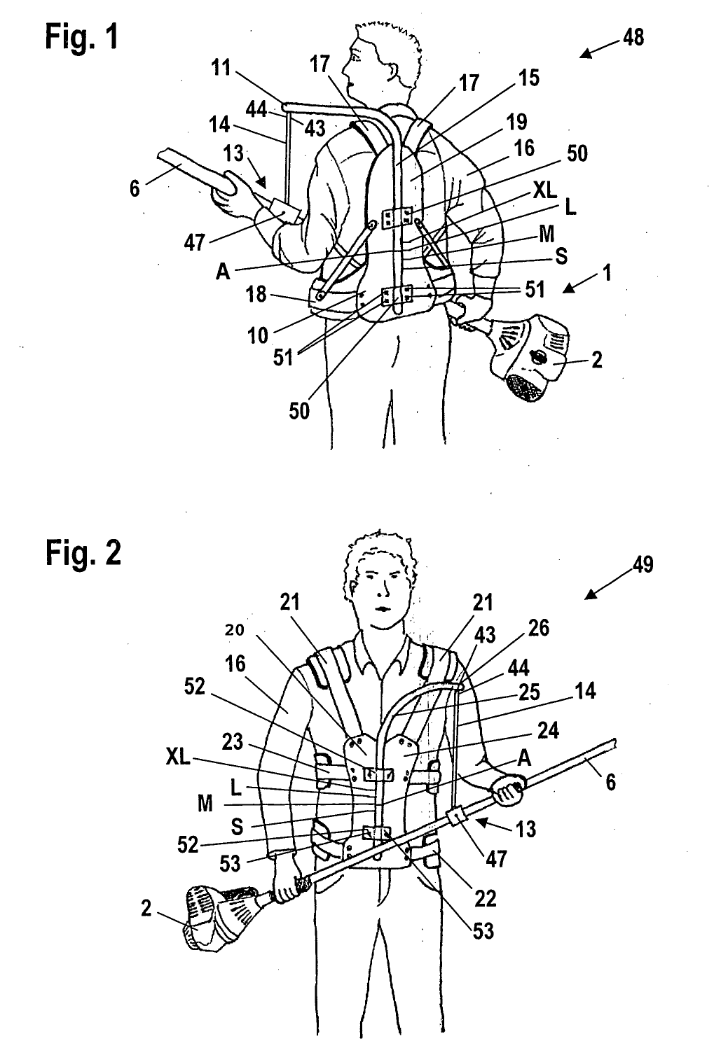

Referring now to the drawings in detail, FIG. 1 shows an operator 16 who is equipped with a carrying system 48 on which is disposed an implement 1, in this case a pole pruner. Instead of a pole pruner, the carrying system 48 can also be used with another implement, such as a palm cutter, a coffee harvester, a tree trimmer or pruner, or the like. The carrying system 48 has a back support 10, which includes a support plate 19 that the operator 16 carries on two shoulder straps 17 and a waist strap 18. The support plate 19 is placed on the back of the operator 16. A carrying arm 15 is fixed on the support plate 19 via two fittings 50, each of which has four screws 51. When the screws 51 are loosened, the carrying arm 15 can be rotated in the fittings 50 and can be shifted in a longitudinal direction. Provided on the support plate 19 are markings S, M, L, XL, which together with a marking A on the carrying arm 15 define four positions of the carrying arm on the support plate 19. The markings advantageously correspond to garment sizes so that the operator 16 can easily undertake that setting of the carrying arm 15 on the support plate 19 that is appropriate for him or her.

The carrying arm 15 is angled off and extends over the shoulder of the operator 16 to the front of the operator. The carrying arm 15 can also extend over the head of the operator 16. The two ends 43 and 44 of a cable or cord 14 of a receiving means 13 are secured to that end 11 of the carrying arm 15 that extends to the front of the operator 16. The receiving means 13 is mounted on a guide rod 6 of the pole pruner 1 in the region of the center of gravity 47 of the pole pruner. Secured to one end of the guide rod 6 is a housing 2 in which is disposed a drive motor, in particular an internal combustion engine, that drives a saw chain that is not shown in FIG. 1 and is disposed at the opposite end of the guide rod 6.

In the embodiment shown in FIG. 2, the operator 16 carries a carrying system 49 having a stomach support 20. The stomach support 20 is carried by the operator 16 on two shoulder straps 21, a back strap 23 and a waist strap 22. The straps carry a support plate 24 that is disposed on the stomach of the operator 16. Secured to the support plate 24 is a carrying arm 25 that extends forwardly and upwardly from the stomach of the operator 16. The two ends 43 and 44 of the cable 14 of the receiving means 13 are secured to that end 26 of the carrying arm 25 that faces away from the operator 16. The carrying arm 15 is secured to the support plate 24 by two fittings 52, each of which is fixed to the support plate by two screws 53. By loosening the screws 53, the carrying arm 25 can be shifted in the direction of the fittings 52, in other words in the vertical direction, and can also be rotated about the vertical axis. To facilitate setting of the position of the carrying arm 25 on the support plate 24, the carrying arm 25 has a marking A, and markings S, M, L, XL are provided on the support plate 24 that correlate to garment sizes.

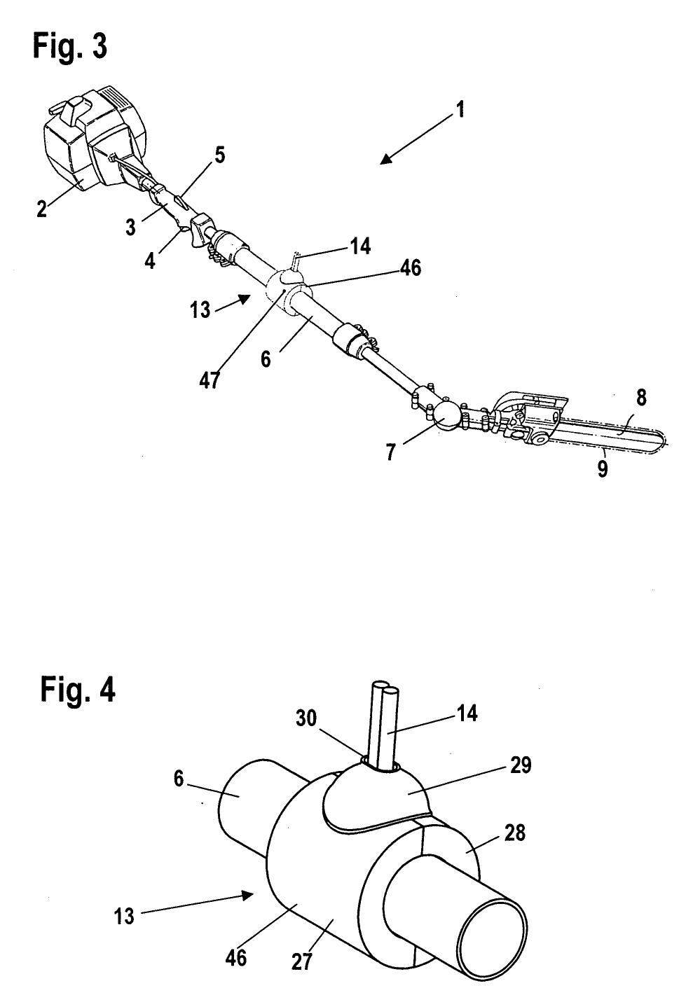

In FIG. 3, the pole pruner 1 is illustrated in perspective. Secured to the guide rod 6 adjacent to the housing 2 is a handle 3 on which are disposed a gas throttle 4 and a throttle lock 5. During operation, a hand of the operator rests on the handle 3. The other hand of the operator grasps the guide rod 6, as shown in FIGS. 1 and 2. The receiving means 13 has a housing 46 that is disposed on the guide rod 6 in the vicinity of the center of gravity 47 of the pole pruner 1. Disposed on that end of the guide rod 6 that is opposite the housing 46 is a guide bar 8 about which circulates a saw chain 9. Provided between the guide rod 6 and the guide bar 8 is a joint 7 by means of which the guide bar, along with the saw chain 9 that circulates about it, are disposed on that end of the guide rod 6 facing away from the housing 2 so as to be angled off relative to the guide rod. However, the guide rod 6 can also be linearly secured to the guide bar 8.

FIG. 4 is an enlarged view of the receiving means 13. The housing 46 is composed of two half shells 27 and 28, and has a cylindrical configuration. Provided in the region where the cable 14 exits the housing 46 is a cap 29 having an opening 30. The cable 14 exits the housing 46 through the opening 30. The cap 29 is convexly curved toward the outside relative to the housing 46.

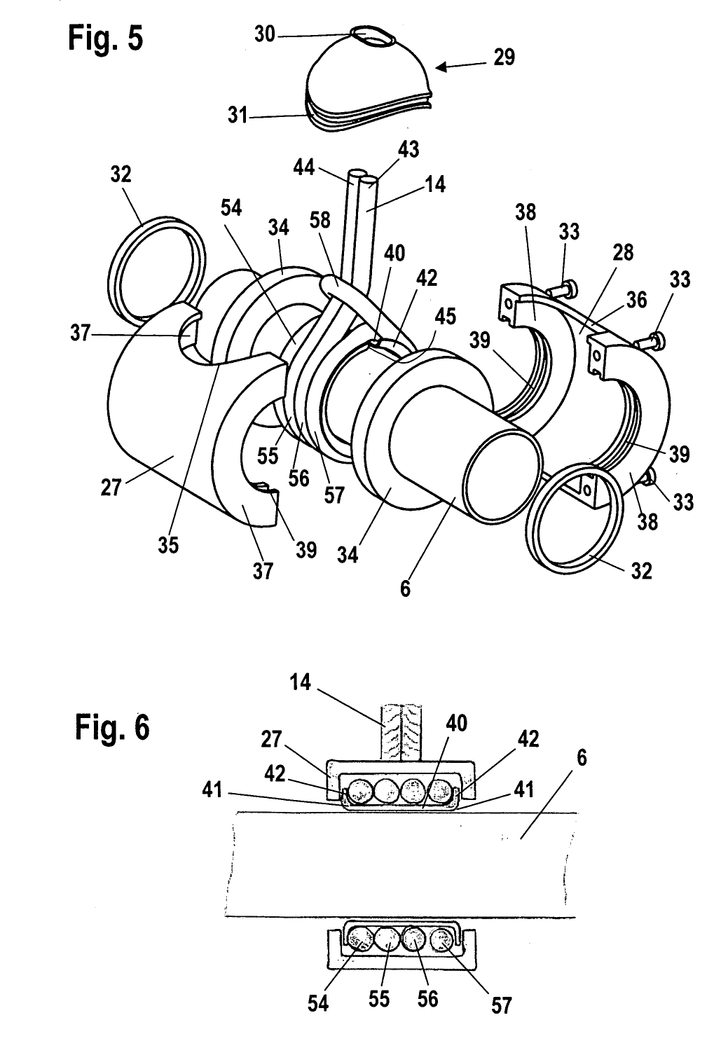

As can be seen from the exploded view of FIG. 5, that end of the cap 29 that rests against the half shells 27 and 28 is provided with a circumferential groove 31 into which the half shells 27 and 28 extend, thus fixing the cap 29. In the region of the cap 29, the half shells 27 and 28 are provided with semicircular recesses 35 and 36. At those ends that are disposed in the longitudinal direction of the guide rod 6, the half shells 27 and 28 are provided with walls 37 and 38 that project radially inwardly from the outer sides of the half shells 27 and 28 to the guide rod 6. On those surfaces that face the guide rod 6, the half shells 27 and 28 are provided with a groove 39 in which a respective sealing ring 32 is guided. The sealing ring 32 is advantageously made of felt and seals the gap between the guide rod 6 and the housing 46. The cable 14 is disposed on the guide rod 6 in a guide means 40. The guide means 40 is embodied as a slotted tubular section, with the slot 45 extending in the longitudinal direction of the guide rod 6. Disposed on each of the ends 41 (FIG. 6) that are disposed in the longitudinal direction of the guide rod 6 is a collar or flange 42 that extends radially outwardly. Respective disks or washers 34 are disposed between the walls 37 and 38 and the guide means 40. The two half shells 27 and 28 are interconnected by four screws 33. In this way, the receiving means 13 can also be fixed on a guide rod 6 at a later point in time.

The cable 14 is looped about the guide means 40 via a Prusik knot. In so doing, the cable 14 is looped nearly four times about the guide means 40. An outer loop 54 and an adjacent inner loop 55 extend in the same direction. Similarly, an inner loop 56 and an outer loop 57 extend in the same direction relative to one another and opposite to the loops 54 and 55. The ends 43 and 44 of the two inner loops 55 and 56 lead to the carrying arm 25 and are guided through a loop 58 formed by the interconnected outer loops 54 and 57. When there is tension in the cable 14, the Prusik knot pulls together, and the loop 58 fixes the cable 14. When the cable 14 is relaxed, the guide means 40 presses the Prusik knot open. As a result, the receiving means 13 can be shifted on the guide rod 6. It should be noted that also without the guide means 40 the Prusik knot can be shifted on the guide rod 6 in the relaxed state.

Instead of a Prusik knot, other knots could also be used. A mere looping around the guide rod can be advantageous. The receiving means 13 can also be fixed to the guide rod 6 by other means. The cable 14 can be elastic.

The carrying systems 48 and 49 can advantageously be used for topping or lopping trees. For this purpose, the pole pruner 1 is secured in position 47, on the carrying system 48 or 49 in the region of its center of gravity 47. As a result, the guide rod 6 is disposed approximately horizontally, or is inclined slightly relative to the horizontal. Due to the horizontal position, or the aforementioned inclination, of the guide rod, the height of the guide bar 8 above the ground is prescribed, and can be easily kept constant by the operator 16. To top a tree, the operator carries out a cutting of the tree all the way around with the pole pruner 1 that is disposed on the carrying system 48, 49. In this connection, the tree is advantageously topped at a height of about 1.0 m to about 1.8 m. A cut at a height of about 1.5 m is particularly advantageous. The topping of the tree causes it to die away. The topping at a prescribed height can prevent wild growth, which can occur when cutting close to the ground.

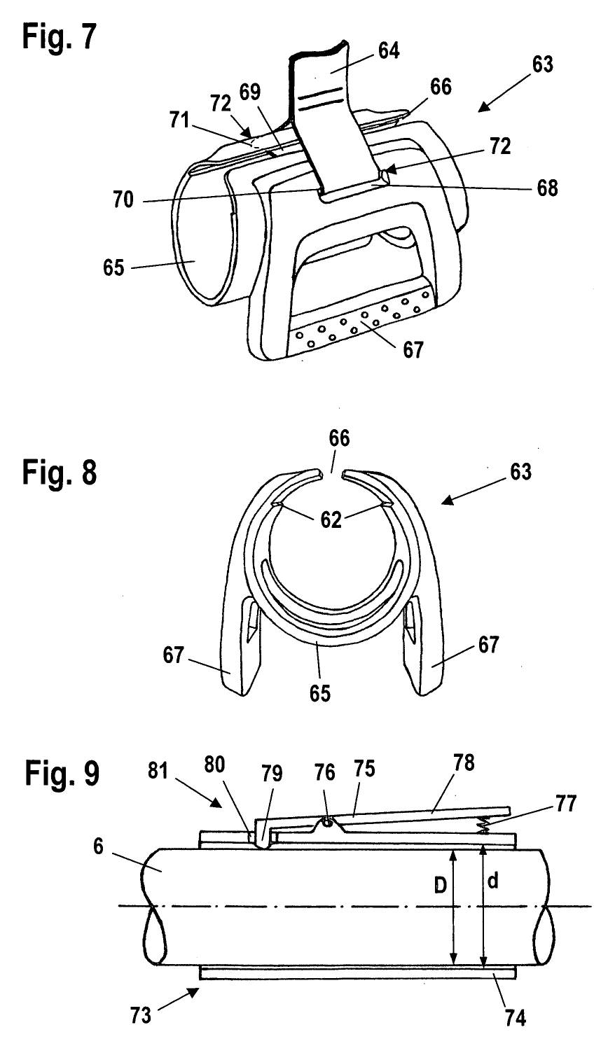

FIGS. 7 and 8 show an embodiment of a receiving means 63 for the guide rod 6 of an implement. The receiving means 63 is provided with a mounting support 65 that extends about the guide rod 6 of the implement. The mounting support 65 has a slot 66, and is in particular, resiliently elastic, so that it automatically clamps onto the guide rod 6. The receiving means 63 also has a strap 64, a portion 69 of which presses against the guide rod 6 of an implement that is disposed in the mounting support 65. The two ends 70 and 71 of the strap 64 that delimit the portion 69 are held in openings 68 on the mounting support 65. The openings 68 are disposed at sections of the mounting support 65 that are opposite one another on the guide rod 6. In this connection, the openings 68 are provided on both sides of the slot 66 in those regions of the mounting support 65 that adjoin the slot 66. The strap 64 is respectively held in an opening 68 via a loop 72. Formed on that side of the mounting support 65 facing away from the slot 66 are gripping means 67 for pressing on the mounting support 65.

When a guide rod 6 is disposed in the mounting support 65, the portion 69 of the strap 64 presses the guide rod 6 into the mounting support 65 due to the implement's own weight. When the strap 64 is relaxed, in other words when the implement is raised, the portion 69 of the strap 64 is loosened, so that the guide rod 6 can be shifted in the receiving means 63. Loosening of the strap 64 can be enhanced by the operator by actuating the gripping means 67 and pressing on the mounting support 65. As shown in FIG. 8, respective shoulders 62 are formed on the inner side of the mounting support 65 in the region of the openings 68. This ensures that the mounting support 65 can rest completely against the guide rod 6 in those regions that are adjacent to the portion 69 of the strap 64. Since the strap 64 is disposed in loops 72 at the opening 68, the strap 64 is movable relative to the mounting support 65.

A further embodiment is shown in FIG. 9. The receiving means 73 shown therein is provided with a tubular section 74, the inner diameter d of which is greater than the outer diameter D of a guide rod 6 that is disposed in the receiving means 73. Thus, the tubular section 74 is movable relative to the guide rod 6. To fix the receiving means 73 on the guide rod 6, the receiving means 73 is provided with a fixing means 81, which is provided with a clamping lever 75, which is pivotably held on a support 76 on the tubular section 74. One end of the clamping lever 75 forms an actuating section 78 at which the operator 16 can actuate, and in particular release, the clamping lever 75. The actuating section 78 is spring-mounted relative to the tubular section 74 via a spring 77. The opposite section of the clamping lever 75 is embodied as a clamping section 79 and extends through an opening 80 in the tubular section 74. The clamping section 79 presses against the guide rod 6 and thus fixes it in the tubular section 74. The spring 77 ensures that the tubular section 74 cannot accidentally come loose. By actuating the actuating section 78, the fixing means 81 can easily be released against the force of the spring 77, and the receiving means 73 can be shifted in the direction of the longitudinal axis of the guide rod 6.

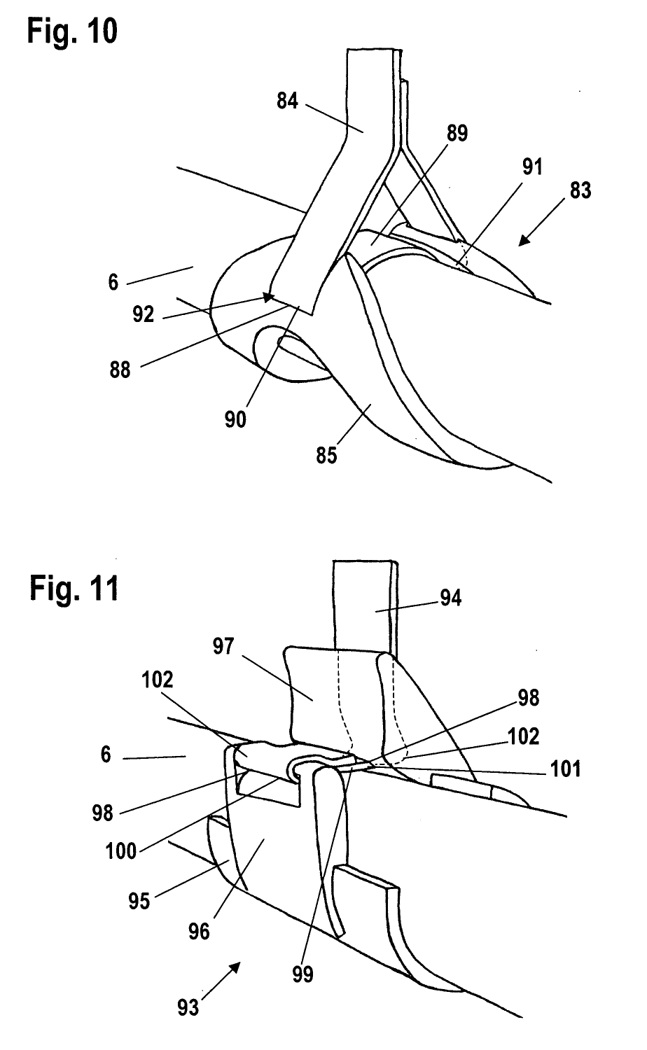

In the embodiment shown in FIG. 10, a receiving means 83 having a strap 84 is provided. The receiving means 83 is provided with a mounting support 85 that extends approximately half way around the guide rod 6. Provided on the mounting support 85 are two openings 88 that are disposed in the opposite ends of the mounting support 85. Via a respective loop 92, the strap 85 is guided through the openings 88. The two loops 92 delimit a portion 89 of the strap 84 that rests against the guide rod 6. The loops 92 are disposed at the two ends 90 and 91 of the portion 89 of the strap 84. The mounting support 85 can be made of a solid material. However, the mounting support 85 advantageously has an elastic configuration, so that it can conform to the guide rod 6. Consequently, the receiving means 83 can be used with implements that have different guide rod diameters. During operation, the weight of the implement presses in the mounting support 85. This tensions the strap 84 and the portion 89 thereof presses the guide rod 6 into the mounting support 85, thereby fixing the mounting support 85 on the guide rod 6. When the tension in the strap 84 is loosened, the guide rod 6 can be shifted relative to the receiving means 83.

The receiving means 93 shown in FIG. 11 is provided with a mounting support 95, in which is disposed the guide rod 6 of the implement. The mounting support 95 is provided with a section 96 on which is disposed an opening 98 for the strap 94, which is held at the opening 98 via a loop 102. Opposite the section 96, the mounting support 95 is provided with an actuation means 97 that is pivotably mounted on the mounting support 95 about a pivot axis that is disposed parallel to the longitudinal axis of the guide rod 6. The actuating means 97 has an opening 98 through which the strap 94 is guided. At the portion 99 of the strap 94 that is disposed between the two openings 98 the strap 94 rests essentially against the guide rod 6. The portion 99 is delimited by the first end 100, which is fixed on the section 96 and by the second end 101, which is fixed on the actuating means 97. The first end 100 is securely held on the section 96. For this purpose, the end of the strap 94 is fixed on the portion 99 of the strap. During operation, the strap 94 is under tension, so that the portion 99 presses the guide rod 6 into the mounting support 95. To loosen the receiving means 93 from the guide rod 6, the operator must press the actuating means 97 outwardly, in other words, away from the section 96. This relaxes the portion 99, and the mounting support 95 can be shifted along the guide rod 6.

FIG. 12 shows a receiving means 103 that is provided with a mounting support 105, which is embodied as a half shell. Disposed opposite the mounting support 105 is a guide means 106 that is also embodied as a half shell. The mounting support 105 and the guide means 106 can also be monolithically embodied as a slotted tube. The strap 104 is guided through two openings 108 that are disposed across from one another on the mounting support 105. The portion 109 of the strap 104 disposed between the openings 108 is guided in the guide means 106. The two ends 110 and 111 that delimit the portion 109 are guided via loops 112 at the openings 108, so that the strap 104 is movably held at the openings 108. During tension loading of the strap 104, the portion 109 presses the guide means 106 in a direction toward the mounting support 105. As a result, the guide rod 6 is pressed against the mounting support 105 and is clamped between the mounting support and the guide means 106. When the strap 104 is relaxed, the clamping force is reduced and the guide rod 6 can be shifted in the receiving means 103.

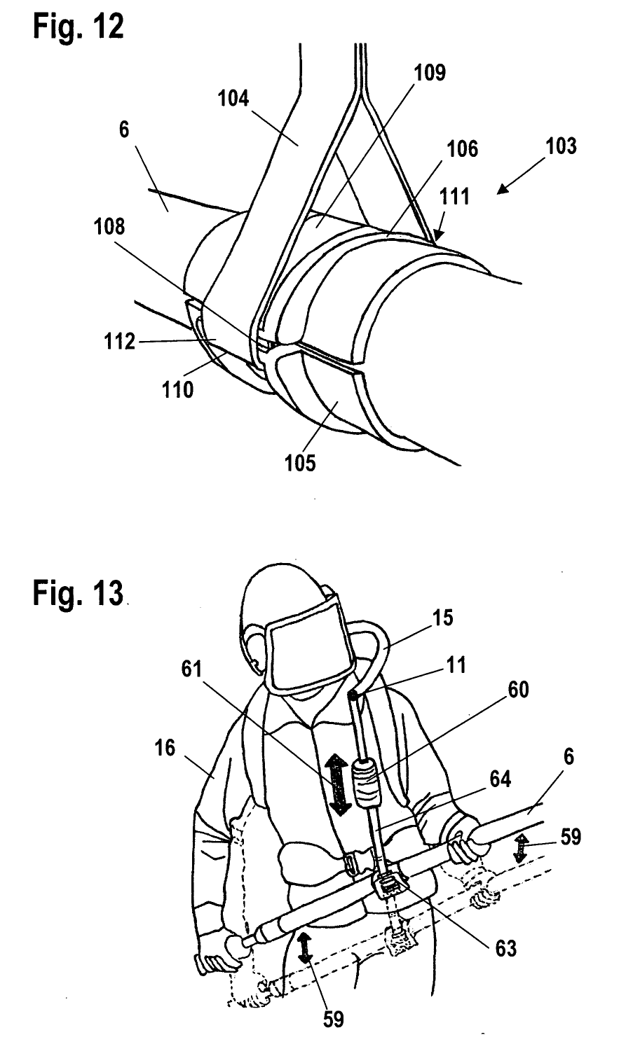

To enable a good adaptation of the height of the receiving means 63, the carrying system is provided with an adjustment device 60. The operator 16 shown in FIG. 13 carries a back support having a carrying arm 15 that extends to the front of the operator. The strap 64 is fixed in position on the end 11 of the carrying arm 15, with the receiving means 63 being suspended on the strap 64. The strap 64 is provided with an adjustment device 60, which enables an adaptation of the length of the strap 64 between the end 11 of the carrying arm 15 and the receiving means 63. By adjusting the length of the strap 64 in the direction of the arrow 61, the guide rod can be adjusted in the direction of the arrow 59. Thus, the height of the guide rod 6 is easily adaptable.

The specification incorporates by reference the disclosure of German priority document 10 2005 001 843.2 filed Jan. 14, 2005.

The present invention is, of course, in no way restricted to the specific disclosure of the specification and drawings, but also encompasses any modifications within the scope of the appended claims.

What I claim is:

1. A carrying system for an implement having a guide rod, comprising:
a carrying arm; and
a receiving means held on said carrying arm and adapted to receive said guide rod, wherein in a first state said receiving means is adapted to fix said guide rod in a longitudinal direction of said guide rod, and wherein in a second state said receiving means is displaceable in the longitudinal direction of said guide rod.

2. A carrying system according to claim 1, wherein said receiving means is adapted to fix said guide rod of said implement if the weight of said implement loads said carrying arm, wherein upon relief of said loading said receiving means is displaceable relative to said guide rod, wherein said receiving means includes a connection element that bends easily for holding said receiving means on said carrying arm, and wherein said connection element fixes said guide rod in said connection element during tension and is displaceable along said guide rod upon relief of said tension.

3. A carrying system according to claim 2, wherein said connection element is fixed in position on said carrying arm via an adjustment device.

4. A carrying system according to claim 2, wherein said connection element is a cable that is held on said guide rod via a Prusik knot, and wherein said cable has two ends that are secured to said carrying arm.

5. A carrying system according to claim 2, wherein a guide means is disposed between said connection element and said guide rod, wherein said guide means is resiliently elastic in a radially outward direction, wherein said guide means is essentially cylindrical, wherein said guide means is provided with a slot that extends in a longitudinal direction of said guide means, wherein said guide means is made of spring sheet metal, and wherein said guide means is provided at ends thereof disposed in the longitudinal direction with a collar that faces outwardly relative to said guide rod.

6. A carrying system according to claim 2, wherein said receiving means is provided with a housing that surrounds a portion of said connection element that is disposed in the region of said guide rod, wherein said housing is essentially cylindrical, wherein a sealing means is disposed between said housing and said guide rod, and wherein said sealing means is made of felt.

7. A carrying system according to claim 2, wherein said receiving means is provided with a mounting support and wherein across from said mounting support a portion of said connection element is disposed on said guide rod and presses said guide rod against said mounting support.

8. A carrying system according to claim 7, wherein said portion of said connection element has two ends that are held on said mounting support, wherein at least one of said ends of said portion is held on said mounting support so as to be movable in its longitudinal direction, wherein said at least one movable end is held on said mounting support via a loop, and wherein said connection element is a strap.

9. A carrying system according to claim 8, wherein said receiving means is provided with an actuating means for releasing said connection element, and wherein said actuating means acts upon said movable end of said portion of said connection element.

10. A carrying system according to claim 7, wherein said receiving means is provided with a guide means, and wherein said portion of said connection element rests in said guide means.

11. A carrying system according to claim 1, wherein a releasable fixing means is provided for fixing a position of said receiving means on said guide rod, wherein said fixing means is provided with a clamping lever that is adapted to hold said receiving means on said guide rod, wherein said clamping lever is spring mounted, and wherein said clamping lever is provided with an actuating means for releasing a clamping action.

12. A carrying system according to claim 1, further comprising a back support or a stomach support, wherein said carrying arm is adjustably held on said support, and wherein said carrying system is provided with at least one marking (A, S, M, L. XL) that characterizes a prescribed position of said carrying arm on said support.

13. A method of cutting trees, including the steps of:
using an implement in the form of a pole pruner that is held on a carrying system in the vicinity of a center of gravity of said pole pruner; and
topping a tree with said pole pruner at a prescribed height by cutting said tree all around with said pole pruner.

14. A method according to claim 13, wherein said step of topping said tree is effected at a height of 1.0 to 1.8 m.
